(19) United States
(12) Patent Application Publication
(10) Pub. No.: US 2016/0363979 A1
(43) Pub. Date: Dec. 15, 2016

(54) METHOD AND APPARATUS FOR CONTROLLING POWER OF VIRTUAL DESKTOP CLIENT IN INTEGRATED MANNER

(71) Applicant: Electronics and Telecommunications Research Institute, Daejeon (KR)

(72) Inventors: Soo-Cheol OH, Daejeon (KR); Dae-Won KIM, Daejeon (KR); Sun-Wook KIM, Gyeonggi-do (KR); Seong-Woon KIM, Chungcheongnam-do (KR); Hag-Young KIM, Daejeon (KR); Jong-Bae MOON, Daejeon (KR); Byeong-Thaek OH, Daejeon (KR); Jung-Hyun CHO, Daejeon (KR)

(21) Appl. No.: 15/049,619

(22) Filed: Feb. 22, 2016

(30) Foreign Application Priority Data
Jun. 15, 2015 (KR) 10-2015-0084220

(51) Int. Cl. G06F 1/26; G06F 9/455

(52) U.S. Cl. CPC G06F 1/266; G06F 9/45533

(57) ABSTRACT

An apparatus and method for controlling the power of a virtual desktop client in an integrated manner are disclosed herein. The apparatus includes a monitor power detection unit, a switch control unit, a power conversion unit, and a power supply unit. The monitor power detection unit detects whether power is supplied to a monitor. The switch control unit controls a client power switch for supplying power to a virtual desktop client terminal corresponding to the monitor based on the result of the detection. The power conversion unit converts the electric current of the power. The power supply unit supplies the virtual desktop client terminal with the power whose electric current has been converted such that the virtual desktop client terminal boots up an operating system and executes a virtual desktop client program.

### CROSS-REFERENCE TO RELATED APPLICATION

This application claims the benefit of Korean Patent Application No. 10-2015-0084220, filed Jun. 15, 2015, which is hereby incorporated by reference herein in its entirety.

### BACKGROUND

1. Technical Field

Embodiments of the present invention relate generally to technology for controlling the power of a virtual desktop client and, more particularly, to integrated power control technology that is capable of controlling the power of a client in an integrated manner using the power switch of a monitor.

2. Description of the Related Art

A virtual desktop system corresponds to technology in which a plurality of virtual machines is executed on a single physical server using virtualization technology and the executed virtual machines can be used by a virtual desktop client connected over a network.

A virtual desktop client may include a terminal for a client, a power supply device for the terminal, and a monitor. These components are physically separate from each other. Accordingly, the components may be connected via cables. In this case, the power of the components needs to be separately controlled because the power control switch of the monitor and the power control switch of a virtual desktop client terminal are separately provided.

Recently, a product in which the power of the monitor and the power of the virtual desktop client terminal can be controlled in an integrated manner has been released onto the market. However, it is problematic in that it is expensive because the product is dedicated to a specific terminal. Furthermore, it has a disadvantage in that various monitors available on the market cannot be selected because only a monitor provided by a corresponding virtual desktop client can be used.

Accordingly, there is an urgent need for technology for controlling the power of a virtual desktop client in an integrated manner which is capable of controlling the power of the virtual desktop client terminal and the power of the monitor in an integrated manner and in which the power of the virtual desktop client terminal and the power of the monitor are controlled in an integrated manner using the power switch of the monitor.

In connection with this, Korean Patent Application Publication No. 10-2006-0062780 (published Jun. 12, 2006) discloses a technology related to “Method for Power Management of Monitor and Computer System Performing Power Management of Monitor.”

### SUMMARY

At least one embodiment of the present invention is directed to the provision of power control technology capable of controlling the power of a client terminal and the power of a monitor in an integrated manner in a virtual desktop client.

At least one embodiment of the present invention is directed to a reduction in the cost required to build an integrated power control system by providing technology for controlling the power of a virtual desktop client in an integrated manner that can be applied to various monitors available on the market.

In accordance with an aspect of the present invention, there is provided an apparatus for controlling the power of a virtual desktop client in an integrated manner, including: a monitor power detection unit configured to detect whether power is supplied to a monitor; a switch control unit configured to control a client power switch for supplying power to a virtual desktop client terminal corresponding to the monitor based on the result of the detection; a power conversion unit configured to convert the electric current of the power; and a power supply unit configured to supply the virtual desktop client terminal with the power whose electric current has been converted such that the virtual desktop client terminal boots up an operating system and executes a virtual desktop client program.

The switch control unit may turn on the client power switch when power is supplied to the monitor, and may turn off the client power switch when power supplied to the monitor is blocked.

The apparatus may further include a signal generation unit configured to transfer a termination request signal to the virtual desktop client terminal when power supplied to the monitor is blocked.

The switch control unit may block power supplied to the virtual desktop client terminal by turning off the client power switch if the virtual desktop client terminal has not been terminated for a predetermined termination standby time after the termination request signal has been transferred to the virtual desktop client terminal.

The client power switch may be connected to an AC power line used to supply power to the monitor.

The apparatus may further include a physical power switch configured to forcedly terminate the virtual desktop client terminal if operation of the virtual desktop client terminal is stopped due to an error occurring in the virtual desktop client terminal.

The power conversion unit may convert the power, supplied in accordance with Alternating Current (AC) power, in accordance with Direct Current (DC) power.

The monitor power detection unit may detect whether power is supplied to the monitor by monitoring the AC power line.

In accordance with another aspect of the present invention, there is provided a method of controlling the power of a virtual desktop client in an integrated manner, including: detecting whether power is supplied to a monitor; controlling a client power switch for supplying power to a virtual desktop client terminal corresponding to the monitor based on the result of the detection; converting the electric current of the power; and supplying the virtual desktop client terminal with the power whose electric current has been converted such that the virtual desktop client terminal boots up an operating system and executes a virtual desktop client program.

Controlling the client power switch may include turning on the client power switch when power is supplied to the monitor, and turning off the client power switch when power supplied to the monitor is blocked.

The method may further include transferring a termination request signal to the virtual desktop client terminal when power supplied to the monitor is blocked.

Controlling the client power switch may include determining whether the virtual desktop client terminal has been terminated for a predetermined termination standby time after the termination request signal has been transferred to the virtual desktop client terminal, and power supplied to the virtual desktop client terminal may be blocked by turning off the client power switch if the virtual desktop client terminal has not been terminated for the predetermined termination standby time.

The client power switch may be connected to an AC power line used to supply power to the monitor.

The method may further include forcedly terminating the virtual desktop client terminal if the operation of the virtual desktop client terminal is stopped due to an error occurring in the virtual desktop client terminal.

Converting the electric current of the power may include converting the power, supplied in accordance with AC power, in accordance with DC power.

Detecting whether the power is supplied to the monitor may include detecting whether the power is supplied to the monitor by monitoring the AC power line.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a system for controlling the power of a virtual desktop client in an integrated manner according to an embodiment of the present invention;

FIG. 2 is a block diagram showing an example of the integrated power control apparatus of FIG. 1;

FIG. 3 is a diagram showing a conventional process of controlling the power of a virtual desktop client;

FIG. 4 is a diagram showing a process of controlling the power of a virtual desktop client in an integrated manner according to an embodiment of the present invention;

FIG. 5 is an operation flowchart showing a method of controlling the power of a virtual desktop client in an integrated manner according to an embodiment of the present invention;

FIG. 6 is an operation flowchart showing a process of driving a virtual desktop client terminal by supplying power to the virtual desktop client terminal according to an embodiment of the present invention;

FIG. 7 is an operation flowchart showing a process of terminating a virtual desktop client terminal by blocking power supplied to the virtual desktop client terminal according to an embodiment of the present invention; and

FIG. 8 is a diagram showing physical connection with a monitor that has been achieved by integrating an integrated power control apparatus and a virtual desktop client terminal according to an embodiment of the present invention.

### DETAILED DESCRIPTION

Embodiments of the present invention will be described in detail below with reference to the accompanying drawings. Redundant descriptions and descriptions of well-known functions and configurations that have been deemed to make the gist of the present invention unnecessarily obscure will be omitted below. The embodiments of the present invention are intended to fully describe the present invention to persons having ordinary knowledge in the art to which the present invention pertains. Accordingly, the shapes, sizes, etc. of components in the drawings may be exaggerated to make the description obvious.

Embodiments of the present invention are described in detail below with reference to the accompanying drawings.

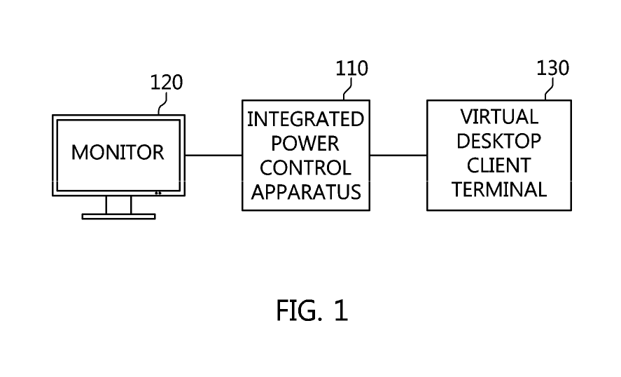

FIG. 1 is a block diagram showing a system for controlling the power of a virtual desktop client in an integrated manner according to an embodiment of the present invention.

Referring to FIG. 1, the system for controlling the power of a virtual desktop client in an integrated manner according to the present embodiment may include an integrated power control apparatus 110, a monitor 120, and a virtual desktop client terminal 130.

The integrated power control apparatus 110 may detect whether power is supplied to the monitor 120.

In this case, the integrated power control apparatus 110 may detect whether power is supplied to the monitor 120 by monitoring an alternating current (AC) power line.

Furthermore, the integrated power control apparatus 110 may control a client power switch for supplying power to the virtual desktop client terminal 130 corresponding to the monitor 120 based on the result of the detection.

In this case, when power is supplied to the monitor 120, the integrated power control apparatus 110 may turn on the client power switch. When power supplied to the monitor 120 is blocked, the integrated power control apparatus 110 may turn off the client power switch.

In this case, if a termination request signal is transferred and then the virtual desktop client terminal 130 is not terminated for a predetermined termination standby time, the integrated power control apparatus 110 may turn on the client power switch to block power supplied to the virtual desktop client terminal 130.

In this case, the client power switch may be connected to the AC power line that is used to supply power to the monitor 120.

Furthermore, the integrated power control apparatus 110 may convert the electric current of power.

In this case, the integrated power control apparatus 110 may convert power corresponding to AC power into power corresponding to direct current (DC) power.

Furthermore, the integrated power control apparatus 110 may supply the virtual desktop client terminal 130 with power whose electric current has been converted such that the virtual desktop client terminal 130 can boot up an operating system and execute a virtual desktop client program.

Furthermore, if power supplied to the monitor 120 is blocked, the integrated power control apparatus 110 may transfer a termination request signal to the virtual desktop client terminal 130.

Furthermore, if the operation of the virtual desktop client terminal 130 has been stopped because an error occurred in the virtual desktop client terminal 130, the integrated power control apparatus 110 may forcedly terminate the virtual desktop client terminal 130.

The monitor 120 includes a power switch for applying power. The terminal 120 may be supplied with power by turning on the power switch.

In this case, when the power switch of the monitor 120 is turned on, the integrated power control apparatus 110 may detect the turning on of the power switch, and may also supply power to the virtual desktop client terminal 130.

In this case, the monitor 120 may receive a video signal from the virtual desktop client terminal 130 to which power has been supplied, and may display the video signal.

In this case, when the power switch of the monitor 120 is turned off, the integrated power control apparatus 110 may detect the turning of the power switch, may transfer a termination request signal to the virtual desktop client terminal 130, and may then block the supply of power.

The virtual desktop client terminal 130 may be supplied with power by the integrated power control apparatus 110.

In this case, when power is supplied, the virtual desktop client terminal 130 may boot up an operating system and execute a virtual desktop client program.

In this case, the virtual desktop client terminal 130 may transfer a video signal, corresponding to the result of the execution of the virtual desktop client program, to the monitor 120 via a video connector.

Furthermore, the virtual desktop client terminal 130 may receive a termination request signal transmitted by the integrated power control apparatus 110.

In this case, the virtual desktop client terminal 130 may receive the termination request signal via a power signal unit, and may perform the process of terminating the virtual desktop client terminal using the power control module of the virtual desktop client terminal 130 in response to the termination request signal.

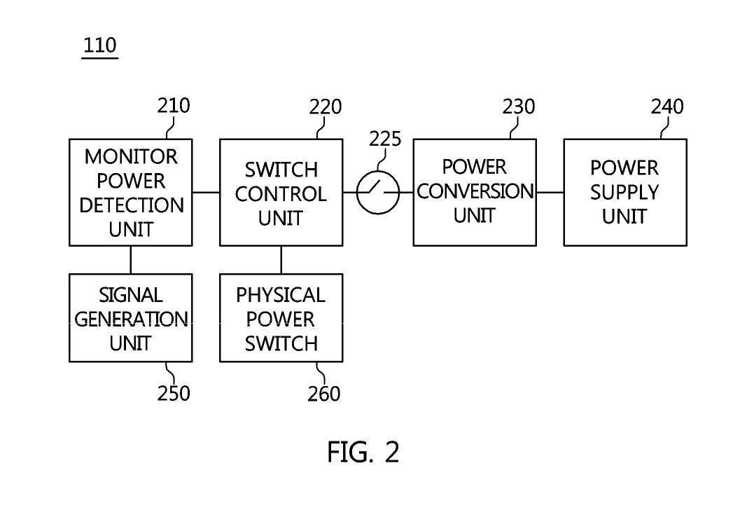

FIG. 2 is a block diagram showing an example of the integrated power control apparatus of FIG. 1.

Referring to FIG. 2, the integrated power control apparatus 110 of FIG. 1 may include a monitor power detection unit 210, a switch control unit 220, a client power switch 225, a power conversion unit 230, a power supply unit 240, a signal generation unit 250, and a physical power switch 260.

A conventional virtual desktop client is inconvenient because power must be separately controlled using separate power control switches included in a monitor and a virtual desktop client terminal, respectively. In order to overcome the inconvenience, a product capable of controlling the power of the monitor and the power of the virtual desktop client terminal in an integrated manner has been developed, but is problematic in that the product is expensive because it has been developed only for a specific product.

Accordingly, in order to overcome the problem, an embodiment of the present invention provides the integrated power control apparatus 110 that can be applied to various monitors in markets and that can control the power of a virtual desktop client terminal using the power switch of a monitor.

The monitor power detection unit 210 may detect whether power is supplied to a monitor.

In this case, the monitor power detection unit 210 may detect whether power is supplied to the monitor by monitoring an AC power line.

That is, when the power switch of the monitor is turned on, an electric current can flow into the monitor through the AC power line, and thus power can start to be supplied to the monitor. In this case, the monitor power detection unit 210 may monitor the AC power line to the monitor, and may detect the electric current flowing into the AC power line and thus power being supplied to the monitor.

The switch control unit 220 may control a client power switch 225 for supplying power to a virtual desktop client terminal corresponding to the monitor based on the result of the detection. For example, the switch control unit 220 may send an electrical signal to the client power switch 225 that can be electrically controlled, and may perform control to selectively turn on and off the client power switch 225 based on the result of detection.

In this case, when power is supplied to the monitor, the switch control unit 220 may turn on the client power switch 225. In contrast, when power supplied to the monitor is blocked, the switch control unit 220 may turn off the client power switch 225. For example, when power is supplied to the monitor, the virtual desktop client terminal needs to be operated, and thus the switch control unit 220 may turn on the client power switch 225 by electrically controlling the client power switch 225 so that power is transferred to the virtual desktop client terminal because. In this case, the virtual desktop client terminal to which power has been supplied boots up an operating system, and may execute a virtual desktop client program when the booting of the operating system is completed.

Furthermore, if power supplied to the monitor is blocked while the virtual desktop client terminal is being operated, the virtual desktop client terminal also performs a termination process. To block power, supplied to the virtual desktop client terminal, accordingly, the switch control unit 220 may turn off the client power switch 225 by electrically controlling the client power switch 225 in order to block the power supplied to the virtual desktop client terminal.

In this case, if the virtual desktop client terminal has not been terminated for a predetermined termination standby time after a termination request signal has been transferred, the switch control unit 220 may block the power supplied to the virtual desktop client terminal by turning off the client power switch 225. For example, assuming that the predetermined termination standby time is 20 seconds, the switch control unit 220 may wait for 20 seconds after the termination request signal has been transferred. If the virtual desktop client terminal is not terminated after the passage of 20 seconds, the switch control unit 220 may terminate the virtual desktop client terminal by turning off the client power switch 225.

In this case, the termination standby time may start to be counted at the same time that the termination request signal is transferred. Furthermore, the termination standby time may be required to secure the time it takes for the operating system of the virtual desktop client terminal to perform a normal termination process. For example, if the termination standby time expires before the operating system of the virtual desktop client terminal completes a termination process, power supplied to the virtual desktop client terminal is forcedly blocked, and thus the operating system stored in a storage device may be damaged.

Accordingly, the termination standby time may be set to the time that is enough for the virtual desktop client terminal to perform a normal termination process.

In this case, the client power switch 225 may be connected to the AC power line used to supply power to the monitor. That is, power is also supplied to the virtual desktop client terminal depending on whether power is supplied to the monitor. Accordingly, the client power switch 225 is connected to the AC power line through which power supplied to the monitor may move, thereby supplying power.

The power conversion unit 230 may convert the electric current of power.

In this case, the power conversion unit 230 may convert power, supplied in accordance with AC power, in accordance with DC power.

In this case, an electric current which flows along an electric line and whose direction changes may be called an alternating current (AC). Furthermore, an electric current which flows in one direction may be called a direct current (DC). In this case, power may be called AC power or DC power depending on whether the electric current is an AC current or a DC current. The AC current and the DC current may be converted into each other and then used depending on the characteristics of the AC current and the DC current.

The characteristics of the AC current and the DC current are now described. The AC current has a frequency and cannot be stored, but a voltage of the AC current can be easily changed. Furthermore, the AC current is suitable for a high capacity load and also for a fixed load corresponding to that of a home or factory.

The AC current can be used for long-distance power transmission because it can easily generate electricity via an AC generator having a simple structure and allows a voltage to be easily increased via a transformer. Furthermore, the AC current is advantageous in that it can be used in an AC motor that has a simpler structure and is more robust than a DC motor. However, the AC is disadvantageous in that it may damage an electric circuit because a voltage is not uniform.

Meanwhile, unlike the AC current, the DC current has no frequency and can be stored, but it is difficult to change the voltage of the AC current. Furthermore, the DC current is suitable for a low capacity load and also for a mobile load, such as a battery.

The DC current does not damage an electric product because the direction in which an electric current flows does not change and the intensity of an electric current is uniform. However, the DC current is disadvantageous in that the structure of a DC generator is complicated and long-distance power transmission is difficult because it is difficult to increase voltage.

The integrated power control apparatus 110 according to the present embodiment may use DC power that does not damage a virtual desktop client terminal, i.e., an electric product, such as a terminal. Accordingly, AC power supplied to a monitor may be converted into DC power and then used.

The power supply unit 240 may supply a virtual desktop client terminal with power whose electric current has been converted such that the virtual desktop client terminal may boot up an operating system and execute a virtual desktop client program.

In this case, when power whose electric current has been converted is supplied to the power unit of the virtual desktop client terminal, the power may be transferred to each of modules included in the virtual desktop client terminal.

In this case, the virtual desktop client terminal may boot up the operating system and then execute the virtual desktop client program.

If power supplied to the monitor is blocked, the signal generation unit 250 may transfer a termination request signal to the virtual desktop client terminal. That is, when the monitor is terminated via the power switch of the monitor, an electric current flowing into the monitor via AC power may also be blocked. The blocking of the electric current may be detected in order to control the virtual desktop client terminal so that it is terminated. Accordingly, the signal generation unit 250 may transfer the termination request signal to the virtual desktop client terminal in order to notify the virtual desktop client terminal that the monitor has been terminated. Furthermore, the virtual desktop client terminal may also be controlled such that it performs a termination process.

In this case, if the termination request signal is transferred to the power signal unit of the virtual desktop client terminal, the power control module of the virtual desktop client terminal may detect the termination request signal and perform the process of terminating the virtual desktop client terminal.

If the operation of the virtual desktop client terminal has been stopped due to an error occurring in the virtual desktop client terminal, the physical power switch 260 may forcedly terminate the virtual desktop client terminal. For example, if the virtual desktop client terminal is unable to be terminated via the termination request signal due to an error occurring in the virtual desktop client terminal, the virtual desktop client terminal may be forcedly terminated by a user. In this case, power supplied to the virtual desktop client terminal may be blocked by cutting off the AC power line to which power is supplied via the physical power switch 260.

Accordingly, the physical power switch 260 may be always turned on when the virtual desktop client terminal is in a normal operation state. Furthermore, in order to prevent the physical power switch 260 from being turned off dud to a user's mistake, a protection device for protecting the physical power switch 260 may be included in the physical power switch 260.

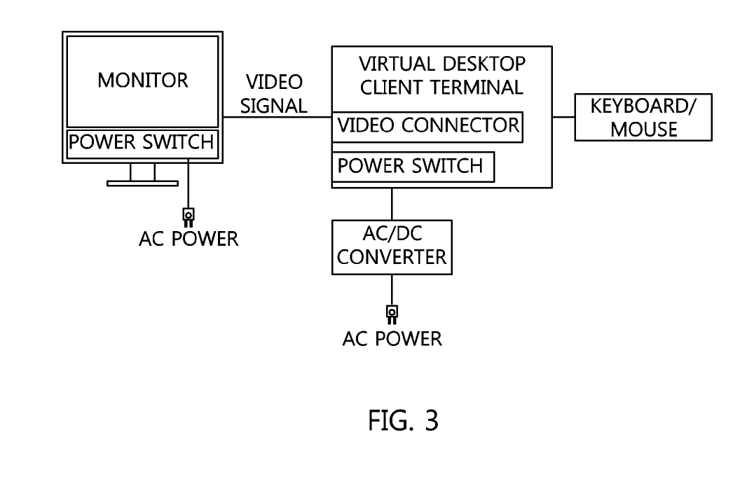

FIG. 3 is a diagram showing a conventional process of controlling the power of a virtual desktop client.

From FIG. 3, it may be seen that in the conventional virtual desktop client, the power of a monitor and the power of a virtual desktop client terminal are separate from each other.

That is, since the power switch of the monitor and the power switch of the virtual desktop client terminal are separately present, the power switches of the monitor and the virtual desktop client terminal must be separately turned on or off in order to turn on or off the monitor and the virtual desktop client terminal.

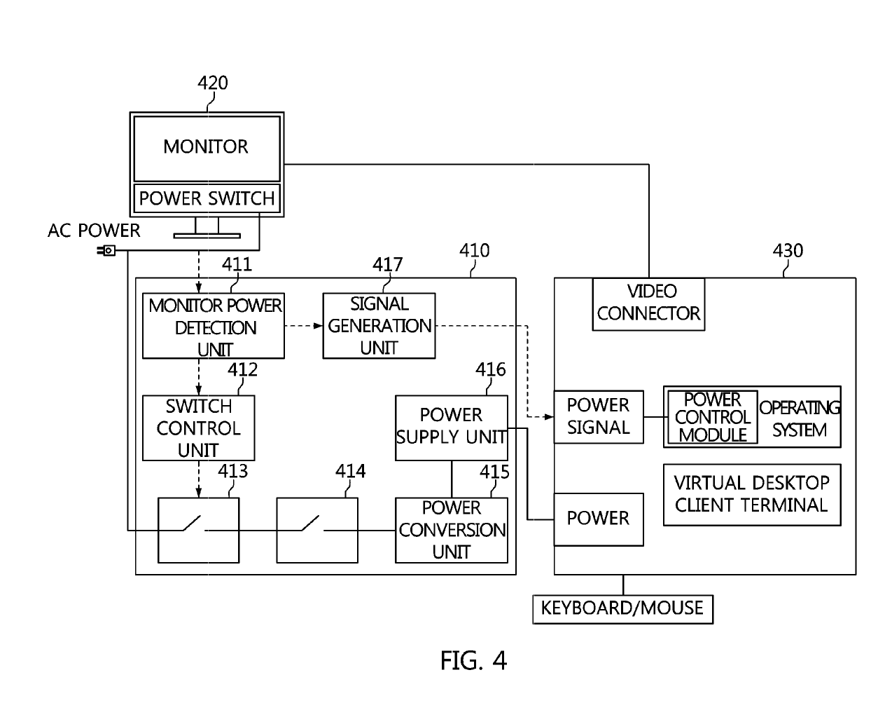

Accordingly, inconvenience arises because the monitor and the virtual desktop client terminal must be separately controlled when the virtual desktop client is operated or terminated. In order to overcome this inconvenience, an embodiment of the present invention proposes a system that is capable of controlling the power of a monitor and the power of a virtual desktop client terminal in an integrated manner, as in the system shown in FIG. 4.

FIG. 4 is a diagram showing a process of controlling the power of a virtual desktop client in an integrated manner according to an embodiment of the present invention.

Referring to FIG. 4, a virtual desktop client according to an embodiment of the present invention may include an integrated power control apparatus 410, a monitor 420, and a virtual desktop client terminal 430.

Referring to FIG. 4, when the power switch of the monitor 420 is turned on, power may be supplied to the monitor 420 via AC power.

In this case, the monitor power detection unit 411 of the integrated power control apparatus 410 may detect power being supplied to the monitor 420 by monitoring an AC power line.

Thereafter, the integrated power control apparatus 410 may turn on a client power switch 413 using a switch control unit 412 so that power is transferred to a power conversion unit 415.

In this case, a physical power switch 414 may be in a turned-on state.

Thereafter, the power conversion unit 415 of the integrated power control apparatus 410 may convert AC power into DC power in accordance with the virtual desktop client terminal 430.

Thereafter, the converted DC power may be supplied to the power unit of the virtual desktop client terminal 430 via a power supply unit 416.

In this case, the power control module of the virtual desktop client terminal 430 may detect the supply of the DC power, and may boot up an operating system using the supplied DC power.

Thereafter, the virtual desktop client terminal 430 may execute a virtual desktop client program so that a video signal corresponding to the result of the execution of the virtual desktop client program is transferred to the monitor 420.

Furthermore, when the power switch of the monitor 420 is turned off, the monitor power detection unit 411 of the integrated power control apparatus 410 may detect power, supplied to the monitor 420, having been blocked by monitoring the AC power line.

Thereafter, the integrated power control apparatus 410 may transfer a termination request signal to the virtual desktop client terminal via a signal generation unit 417, and may block power by turning off the client power switch 413 using the switch control unit 412.

In this case, the switch control unit 412 may wait for a predetermined termination standby time so that the operating system of the virtual desktop client terminal 430 performs a normal termination process, and may perform control so that the client power switch 413 is turned off.

If the virtual desktop client terminal 430 is unable to autonomously stop its operation due to an error occurring in the virtual desktop client terminal 430, a user may terminate the virtual desktop client terminal 430 by turning off the physical power switch 414 so that power supplied to the virtual desktop client terminal 430 is blocked.

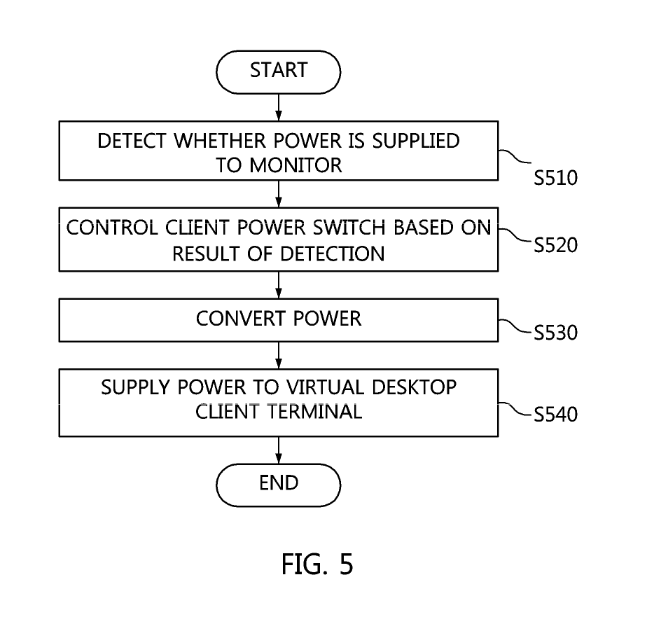

FIG. 5 is an operation flowchart showing a method of controlling the power of a virtual desktop client in an integrated manner according to an embodiment of the present invention.

Referring to FIG. 5, in the method of controlling the power of a virtual desktop client in an integrated manner according to the present embodiment, whether power is supplied to a monitor may be detected at step 5510.

In this case, the detection may be performed by monitoring an AC power line.

That is, when the power switch of the monitor is turned on, an electric current may flow into the monitor via AC power, and thus power may start to be supplied to the monitor. In this case, the electric current flows into the AC power line, and the supply of power to the monitor may be detected by monitoring the AC power line of the monitor.

Furthermore, in the method of controlling the power of a virtual desktop client in an integrated manner according to the present embodiment, the client power switch for supplying power to a virtual desktop client terminal corresponding to the monitor may be controlled based on the result of the detection at step 5520. For example, the client power switch may be controlled so that it is turned on or off based on the result of the detection by sending an electrical signal to the client power switch that can be electrically controlled.

In this case, when power is supplied to the monitor, the client power switch may be turned on. When power supplied to the monitor is blocked, the client power switch may be turned off. For example, when power is supplied to the monitor, the client power switch may be turned on by electrically controlling the client power switch so that power is also transferred to the virtual desktop client terminal because the virtual desktop client terminal needs to be executed. In this case, the virtual desktop client terminal to which power has been supplied may boot up an operating system. Once the operating system has been booted up, the virtual desktop client terminal may execute a virtual desktop client program.

Furthermore, if power supplied to the monitor is blocked while the virtual desktop client terminal is being operated, the virtual desktop client terminal also performs a termination process. Accordingly, in order to block power supplied to the virtual desktop client terminal, the client power switch may be turned off by electrically controlling the client power switch.

In this case, if the virtual desktop client terminal has not been terminated for a predetermined termination standby time after a termination request signal has been transferred, the power supplied to the virtual desktop client terminal may be blocked by turning off the client power switch. For example, assuming that the predetermined termination standby time is 20 seconds, waiting may be performed for 20 seconds after the termination request signal has been transferred. If the virtual desktop client terminal has not been terminated after the passage of 20 seconds, the virtual desktop client terminal may be terminated by turning off the client power switch.

In this case, the termination standby time may start to be counted at the same time that the termination request signal is transferred. Furthermore, the termination standby time may be required to secure the time it takes for the operating system of the virtual desktop client terminal to perform a normal termination process. For example, if the termination standby time expires before the operating system of the virtual desktop client terminal completes a termination process, power supplied to the virtual desktop client terminal is forcedly blocked, and thus the operating system stored in a storage device may be damaged.

Accordingly, the termination standby time may be set to the time that is enough for the virtual desktop client terminal to perform a normal termination process.

In this case, the client power switch may be connected to the AC power line used to supply power to the monitor. That is, power is also supplied to the virtual desktop client terminal depending on whether power is supplied to the monitor. Accordingly, the client power switch is connected to the AC power line through which power supplied to the monitor may move, thereby supplying power.

Furthermore, in the method of controlling the power of a virtual desktop client in an integrated manner according to an embodiment of the present invention, the electric current of power may be converted at step S530.

In this case, power supplied in accordance with AC power may be converted in accordance with DC power.

In this case, an electric current which flows along an electric line and whose direction changes may be called an AC current. Furthermore, an electric current that flows in one direction may be called a DC current. In this case, power may be called AC power or DC power depending on whether the electric current is an AC current or a DC current. The AC current and the DC current may be converted into each other and then used depending on the characteristics of the AC current and the DC current.

The characteristics of the AC current and the DC current are now described. The AC current has a frequency and cannot be stored, but a voltage of the AC current can be easily changed. Furthermore, the AC current is suitable for a high capacity load and also for a fixed load corresponding to that of a home or factory.

The AC current can be used for long-distance power transmission because it can easily generate electricity via an AC generator having a simple structure and allows a voltage to be easily increased via a transformer. Furthermore, the AC current is advantageous in that it can be used in an AC motor that has a simpler structure and is more robust than a DC motor. However, the AC is disadvantageous in that it may damage an electric circuit because a voltage is not uniform.

Meanwhile, unlike the AC current, the DC current has no frequency and can be stored, but it is difficult to change the voltage of the AC current. Furthermore, the DC current is suitable for a low capacity load and also for a mobile load, such as a battery.

The DC current does not damage an electric product because the direction in which an electric current flows does not change and the intensity of an electric current is uniform. However, the DC current is disadvantageous in that the structure of a DC generator is complicated and long-distance power transmission is difficult because it is difficult to increase voltage.

The integrated power control apparatus 110 according to the present embodiment may use DC power that does not damage a virtual desktop client terminal, i.e., an electric product, such as a terminal. Accordingly, AC power supplied to a monitor may be converted into DC power and then used.

Furthermore, in the method of controlling the power of a virtual desktop client in an integrated manner according to an embodiment of the present invention, power whose electric current has been converted may be supplied to the virtual desktop client terminal so that the virtual desktop client terminal may boot up an operating system and execute a virtual desktop client program at step S540.

In this case, when power whose electric current has been converted is supplied to the power unit of the virtual desktop client terminal, the power may be transferred to each of modules included in the virtual desktop client terminal.

In this case, the virtual desktop client terminal may boot up the operating system and then execute the virtual desktop client program.

Furthermore, although not shown in FIG. 5, in the method of controlling the power of a virtual desktop client in an integrated manner according to an embodiment of the present invention, if power supplied to the monitor is blocked, a termination request signal may be transferred to the virtual desktop client terminal. That is, when the monitor is terminated via the power switch of the monitor, an electric current flowing into the monitor via AC power may also be blocked. The blocking of the electric current may be detected in order to control the virtual desktop client terminal so that it is terminated. Accordingly, the termination request signal may be transferred to the virtual desktop client terminal in order to notify the virtual desktop client terminal that the monitor has been terminated. Furthermore, the virtual desktop client terminal may also be controlled so that it performs a termination process.

In this case, if the termination request signal is transferred to the power signal unit of the virtual desktop client terminal, the power control module of the virtual desktop client terminal may detect the termination request signal and perform the process of terminating the virtual desktop client terminal.

Furthermore, although not shown in FIG. 5, in the method of controlling the power of a virtual desktop client in an integrated manner according to the present embodiment, if the operation of the virtual desktop client terminal has been stopped due to an error occurring in the virtual desktop client terminal, the virtual desktop client terminal may be forcedly terminated. For example, if the virtual desktop client terminal is unable to be terminated via the termination request signal due to an error occurring in the virtual desktop client terminal, the virtual desktop client terminal may be forcedly terminated by a user. In this case, power supplied to the virtual desktop client terminal may be blocked by cutting off the AC power line to which power is supplied via the physical power switch.

Accordingly, the physical power switch may be always turned on when the virtual desktop client terminal is in a normal operation state. Furthermore, in order to prevent the physical power switch from being turned off dud to a user's mistake, a protection device for protecting the physical power switch may be included in the physical power switch.

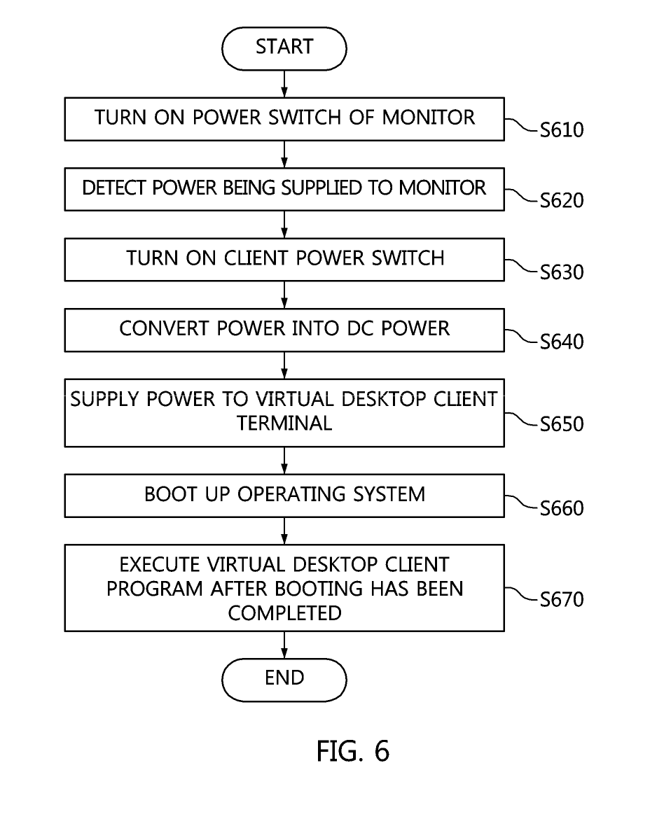

FIG. 6 is an operation flowchart showing a process of driving a virtual desktop client terminal by supplying power to the virtual desktop client terminal according to an embodiment of the present invention.

Referring to FIG. 6, in the process of supplying power to a virtual desktop client terminal and executing the virtual desktop client terminal according to the present embodiment, first, the power switch of a monitor may be turned on at step S610.

Thereafter, power is supplied to the monitor. The integrated power control apparatus may detect the supply of power to the monitor by monitoring an AC power line in which AC power moves at step S620.

When detecting power supplied to the monitor, the integrated power control apparatus may turn on a client power switch for supplying power to the virtual desktop client terminal corresponding to the monitor at step S630.

Thereafter, the integrated power control apparatus may convert the AC power, moved via the client power switch, into DC power corresponding to the virtual desktop client terminal at step S640, and may supply the converted DC power to the virtual desktop client terminal at step S650.

Thereafter, the virtual desktop client terminal boots up an operating system based on the supplied DC power at step S660. When the booting up of the operating system is completed, the virtual desktop client terminal may execute a virtual desktop client program at step S670.

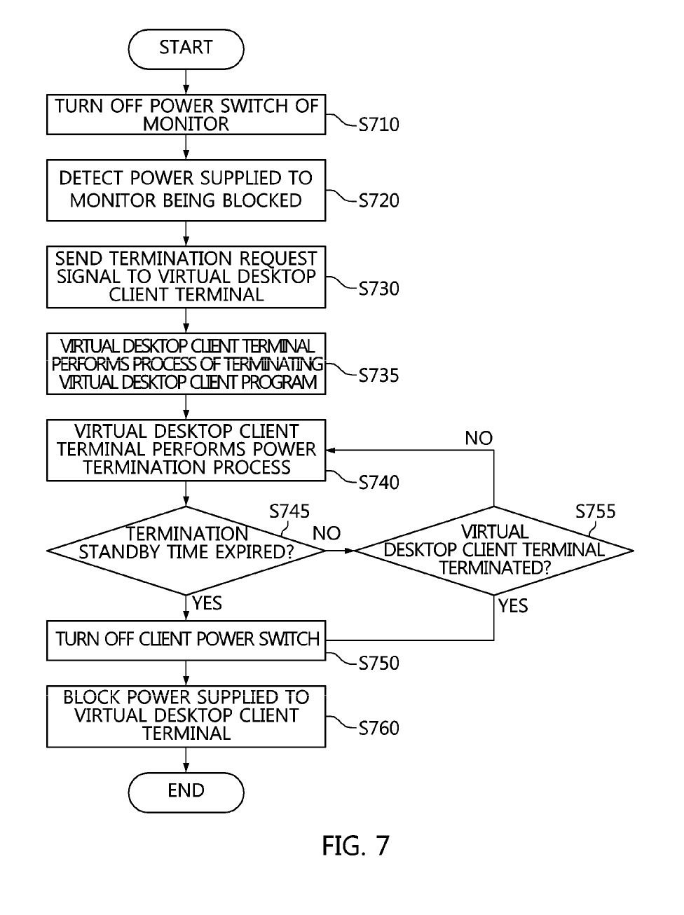

FIG. 7 is an operation flowchart showing a process of terminating a virtual desktop client terminal by blocking power supplied to the virtual desktop client terminal according to an embodiment of the present invention.

Referring to FIG. 7, in the process of terminating the virtual desktop client terminal by blocking power supplied to the virtual desktop client terminal according to the present embodiment, first, the power switch of a monitor may be turned off at step S710.

Thereafter, power supplied to the monitor is blocked. The integrated power control apparatus may detect power supplied to the monitor having been blocked by monitoring an AC power line in which AC power moves at step S720.

When the blocking of power supplied to the monitor is detected, the integrated power control apparatus may send a termination request signal to the virtual desktop client terminal at step S730.

In response to the termination request signal, the virtual desktop client terminal may terminate the execution of a virtual desktop client program first at step S735, and may perform the process of terminating the power of the virtual desktop client terminal at step S740.

Thereafter, the integrated power control apparatus determines whether a predetermined termination standby time has expired at step S745. If, as a result of the determination at step S745, it is determined that the termination standby time has expired, the integrated power control apparatus may turn off a client power switch at step S750.

Furthermore, if, as a result of the determination at step S745, it is determined that the termination standby time has not expired, the integrated power control apparatus may determine whether the virtual desktop client terminal has been terminated at step S755.

If, as a result of the determination at step S755, it is determined that the virtual desktop client terminal has not been terminated, the integrated power control apparatus may wait such that the virtual desktop client terminal continues to perform the termination process.

If, as a result of the determination at step S755, it is determined that the virtual desktop client terminal has been terminated, the integrated power control apparatus may block power supplied to the virtual desktop client terminal at step S760 by turning off the client power switch at step S750.

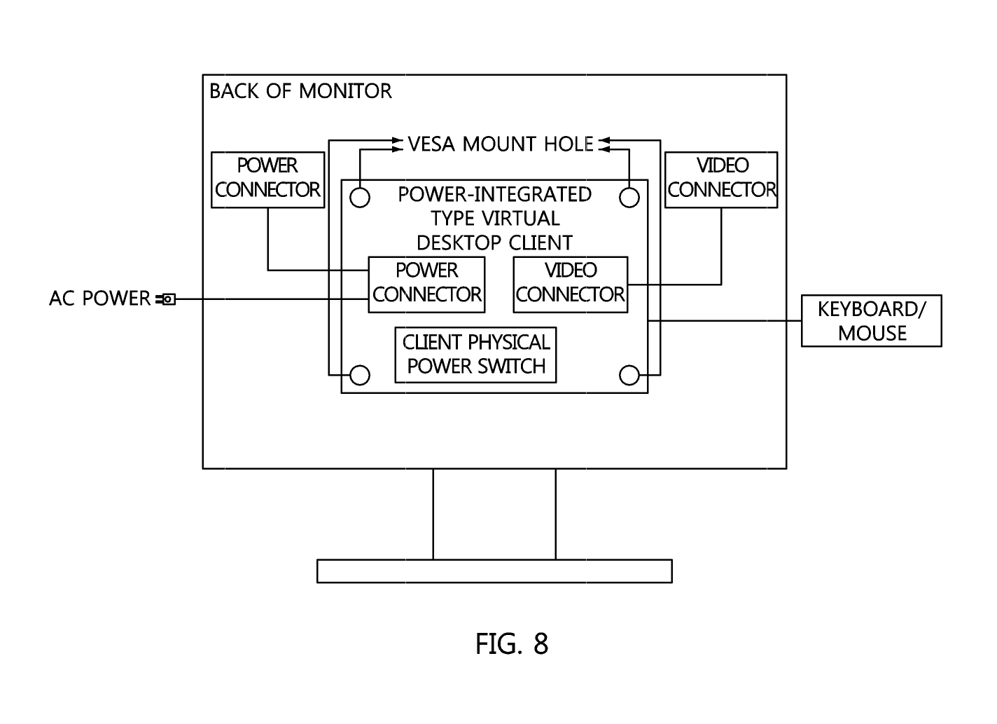

FIG. 8 is a diagram showing physical connection with a monitor that has been achieved by integrating an integrated power control apparatus and a virtual desktop client terminal according to an embodiment of the present invention.

Referring to FIG. 8, a power-integrated type virtual desktop client in which the integrated power control apparatus and the virtual desktop client terminal have been integrated according to the present embodiment invention may be fabricated in a form that is mountable on a VESA mount. The power-integrated-type virtual desktop client may be physically coupled to the VESA mount using a VESA mount hole in the back of the monitor.

In this case, the AC power line of the power-integrated-type virtual desktop client may be connected to a power connector on the back of the monitor. Furthermore, an AC power connector from the power connector may be connected to an AC outlet.

In this case, a video signal line from the vide connector of the power-integrated type virtual desktop client may be connected to a video connector on the back of the monitor.

As described above, at least one embodiment of the present invention can provide power control technology capable of controlling the power of a client terminal and the power of a monitor in an integrated manner in a virtual desktop client.

Furthermore, at least one embodiment of the present invention can reduce the cost required to build an integrated power control system by providing technology for controlling the power of a virtual desktop in an integrated client that can be applied to various monitors in markets.

As described above, the apparatus and method for controlling the power of a virtual desktop client according to the present invention are not limited to the configurations and methods of the aforemtioned embodiments, but some or all of the embodiments may be selectively combined such that the embodiments are modified in various manners.

What is claimed is:

1. An apparatus for controlling power of a virtual desktop client in an integrated manner, comprising:
a monitor power detection unit configured to detect whether power is supplied to a monitor;
a switch control unit configured to control a client power switch for supplying power to a virtual desktop client terminal corresponding to the monitor based on a result of the detection;
a power conversion unit configured to convert an electric current of the power; and
a power supply unit configured to supply the virtual desktop client terminal with the power whose electric current has been converted such that the virtual desktop client terminal boots up an operating system and executes a virtual desktop client program.

2. The apparatus of claim 1, wherein the switch control unit turns on the client power switch when power is supplied to the monitor, and turns off the client power switch when power supplied to the monitor is blocked.

3. The apparatus of claim 2, further comprising a signal generation unit configured to transfer a termination request signal to the virtual desktop client terminal when power supplied to the monitor is blocked.

4. The apparatus of claim 3, wherein the switch control unit blocks power supplied to the virtual desktop client terminal by turning off the client power switch if the virtual desktop client terminal has not been terminated for a predetermined termination standby time after the termination request signal has been transferred to the virtual desktop client terminal.

5. The apparatus of claim 4, wherein the client power switch is connected to an AC power line used to supply power to the monitor.

6. The apparatus of claim 1, further comprising a physical power switch configured to forcedly terminate the virtual desktop client terminal if operation of the virtual desktop client terminal is stopped due to an error occurring in the virtual desktop client terminal.

7. The apparatus of claim 1, wherein the power conversion unit converts the power, supplied in accordance with Alternating Current (AC) power, in accordance with Direct Current (DC) power.

8. The apparatus of claim 5, wherein the monitor power detection unit detects whether power is supplied to the monitor by monitoring the AC power line.

9. The apparatus of claim 1, wherein:
the virtual desktop client program is executed based on driving of the virtual desktop client terminal when power is supplied to the monitor; and
the execution of the virtual desktop client program is terminated based on termination of the virtual desktop client terminal when the power supplied to the monitor is blocked.

10. A method of controlling power of a virtual desktop client in an integrated manner, comprising:
detecting whether power is supplied to a monitor;
controlling a client power switch for supplying power to a virtual desktop client terminal corresponding to the monitor based on a result of the detection;
converting an electric current of the power; and
supplying the virtual desktop client terminal with the power whose electric current has been converted such that the virtual desktop client terminal boots up an operating system and executes a virtual desktop client program.

11. The method of claim 10, wherein controlling the client power switch comprises:
turning on the client power switch when power is supplied to the monitor; and
turning off the client power switch when power supplied to the monitor is blocked.

12. The method of claim 11, further comprising transferring a termination request signal to the virtual desktop client terminal when power supplied to the monitor is blocked.

13. The method of claim 12, wherein:
controlling the client power switch comprises determining whether the virtual desktop client terminal has been terminated for a predetermined termination standby time after the termination request signal has been transferred to the virtual desktop client terminal; and
power supplied to the virtual desktop client terminal is blocked by turning off the client power switch if the virtual desktop client terminal has not been terminated for the predetermined termination standby time.

14. The method of claim 13, wherein the client power switch is connected to an AC power line used to supply power to the monitor.

15. The method of claim 10, further comprising forcedly terminating the virtual desktop client terminal if operation of the virtual desktop client terminal is stopped due to an error occurring in the virtual desktop client terminal.

16. The method of claim 10, wherein converting the electric current of the power comprises converting the power, supplied in accordance with AC power, in accordance with DC power.

17. The method of claim 14, wherein detecting whether the power is supplied to the monitor comprises detecting whether the power is supplied to the monitor by monitoring the AC power line.

18. The method of claim 10, wherein:
the virtual desktop client program is executed based on driving of the virtual desktop client terminal when power is supplied to the monitor; and
the execution of the virtual desktop client program is terminated based on termination of the virtual desktop client terminal when the power supplied to the monitor is blocked.
